(19) United States
(12) Patent Application Publication
(10) Pub. No.: US 2025/0294325 A1
(43) Pub. Date: Sep. 18, 2025

(54) USER EQUIPMENT INITIATION OF RADIO SENSING OPERATION

(71) Applicant: Lenovo (Singapore) Pte Limited, Singapore (SG)

(72) Inventors: Seyedomid TAGHIZADEH MOTLAGH, Oberursel (DE); Ali Ramadan ALI, Kraiburg am Inn (DE); Sher Ali CHEEMA, Ilmenau (DE)

(21) Appl. No.: 18/858,707

(22) PCT Filed: Apr. 21, 2023
(86) PCT No.: PCT/IB2023/054118

§ 371 Date: Oct. 21, 2024

Related U.S. Application Data
(60) Provisional application No. 63/333,972, filed on Apr. 22, 2022.

(51) Int. Cl. H04W 4/38; H04W 8/22; H04W 72/21; H04W 74/0833

(52) U.S. Cl. CPC H04W 4/38; H04W 8/22; H04W 72/21; H04W 74/0833

(57) ABSTRACT

Various aspects of the present disclosure relate to performing radio sensing operations, within a network communications system, which are initiated or requested by a user device, such as user equipment (UE). For example, the technology described herein introduces various messaging or signaling exchanges between user devices and network entities, facilitating the transfer of information between devices/entities to ensure or enhance the performed radio sensing operations, among other benefits.

### CROSS REFERENCE TO RELATED APPLICATIONS

This application claims priority to U.S. Provisional Patent Application No. 63/333,972, filed on Apr. 22, 2022, entitled USER EQUIPMENT INITIATION OF RADIO SENSING OPERATION, which is hereby incorporated by reference in its entirety.

### TECHNICAL FIELD

The present disclosure relates to wireless communications, and more specifically to performing radio sensing operations within a wireless communications system.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

The wireless communications system, via the various communication devices, can perform radio sensing to improve network performance and/or serve various use cases or associated services. Radio sensing operates to obtain environment information by using radio-frequency (RF) signaling to detect objects or areas within an environment, such as a physical location or environment that includes a UE or other user devices.

For example, a radio sensing mechanism, scheme, or technique can include: transmission of a sensing excitation signal (sensing RS) from a sensing Tx node (e.g., a network entity or UE), reception of reflections/echoes of the transmitted sensing excitation signal from the environment by a sensing Rx node (e.g., a network entity or UE), and/or processing of the received reflections to infer information from the environment or objects within the environment.

### SUMMARY

The present disclosure relates to methods, apparatuses, and systems that support performing radio sensing operations, within a network communications system, which are initiated or requested by a user device, such as user equipment. For example, the technology described herein introduces various messaging or signaling exchanges between user devices and network entities, facilitating the transfer of information between devices/entities to ensure or enhance the performed radio sensing operations, among other benefits.

Some implementations of the method and apparatuses described herein may further include a network entity configured to receive, from a UE, a request message including a request for the network entity to perform a radio sensing operation and a type of radio sensing operation to be performed by the network entity, determine whether to perform the requested radio sensing operation, and transmit, to the UE, a response message that includes an indication of the determination by the network entity to perform the requested radio sensing operation.

In some implementations of the method and apparatuses described herein, the request message includes information identifying an object or area of interest targeted by the requested radio sensing operation and/or information identifying an environment within which the requested radio sensing operation is to be performed by the network entity.

In some implementations of the method and apparatuses described herein, the network entity is further configured to transmit configuration information to the UE that includes one or more of a set of time resources, frequency resources, or beam resources for which the UE transmits the sensing request message to the network entity, a set of criteria for the UE to transmit the sensing request message to the network entity, and/or a message type for the sensing request message.

In some implementations of the method and apparatuses described herein, the response message includes an indication that the request is granted by the network entity but the radio sensing operation to be performed by the network entity is different than what was requested by the UE, an indication that the request is granted by the network entity and the radio sensing operation is to be performed at a time period different than a requested time period, an indication that the request has been rejected by the network entity along with information identifying one or more factors for the rejection, an indication that the request is granted by the network entity, including a periodicity or time-pattern for performing the radio sensing operation, an indication the request is granted by the network entity including a granted radio sensing scenario for the UE, an indication of an object or area of interest to be sensed during the requested radio sensing operation, and/or an indication of a quality of service (QOS) for sensing information that results from the radio sensing operation.

In some implementations of the method and apparatuses described herein, transmitting a response message to the UE includes transmitting a first message that indicates the decision by the network entity regarding the network entity performing the requested radio sensing operation and transmitting a second message that indicates information associated with the radio sensing operation.

In some implementations of the method and apparatuses described herein, when the network entity accepts the request to perform the radio sensing operation, the network entity transmits sensing information to the UE that results from the performed radio sensing operation.

In some implementations of the method and apparatuses described herein, the network entity receives the request message from the UE as an uplink control information element via a Physical Uplink Control Channel (PUCCH), as a message via a Physical Random Access Channel (PRACH), and/or as a message via a Physical Uplink Shared Channel (PUSCH).

In some implementations of the method and apparatuses described herein, the network entity transmits the response message to the UE dynamically via a Physical Downlink Control Channel (PDCCH) or semi-persistently via Radio Resource Control (RRC) signaling.

In some implementations of the method and apparatuses described herein, the response message includes information elements indicated by one or more indices of a codebook of the network entity, the codebook identifying parameter combinations for the response message.

In some implementations of the method and apparatuses described herein, the response message includes information elements indicated by one or more indices of a codebook of the network entity, the codebook identifying capability information for the network that identifies capabilities of the network entity to perform the radio sensing operation.

In some implementations of the method and apparatuses described herein, the network entity transmits capability information, which identifies capabilities of the network entity to perform the radio sensing operation, via a broadcast message or a multicast message.

In some implementations of the method and apparatuses described herein, the radio sensing operation is performed by the network entity to obtain information about a physical environment that includes the UE.

In some implementations of the method and apparatuses described herein, the radio sensing operation is performed by the network entity to obtain information about an object proximate to the UE.

Some implementations of the method and apparatuses described herein may further include a UE configured to identify a sensing scenario associated with the UE or an environment that includes the UE and transmit, to a network entity, a request message indicates a request for the network entity to perform a radio sensing operation on behalf of the UE and a type of radio sensing operation to be performed by the network entity.

In some implementations of the method and apparatuses described herein, the UE receives a response message from the network entity that includes a determination by the network entity regarding the network entity performing the requested radio sensing operation.

In some implementations of the method and apparatuses described herein, the type of radio sensing operation is identified by an object identifier number for an object targeted by the requested radio sensing operation, an area-of-interest identifier number for an area targeted by the requested radio sensing operation, an indication of an area of interest defined by a local coordinate system of the UE or the network entity, and/or a feature type to be extracted from the object or area of interest.

In some implementations of the method and apparatuses described herein, the type of radio sensing operation includes an indication of a sensing target key performance indicator (KPI) and a sensing quality of service (QOS) description, including an indication of a significance or priority of the request for the network entity to perform the radio sensing operation on behalf of the UE, a tolerable latency for the requested radio sensing operation, an indication of one or more sensing information security requirements, and/or an indication of reliability or accuracy requirements for the requested radio sensing operation.

In some implementations of the method and apparatuses described herein, the the request message includes an indication of a requested sensing task periodicity, a requested time pattern, and/or a requested validity period.

In some implementations of the method and apparatuses described herein, the type of radio sensing operation includes an indication of the UE as a sensing receiver during the radio sensing operation, a sensing transmitter during the radio sensing operation, or the UE as both a sensing receiver and a sensing transmitter during the radio sensing operation.

In some implementations of the method and apparatuses described herein, the UE receives configuration information from the network entity associated with the UE transmitting a report during a performed sensing operation, and transmits a sensing measurement report to the network entity based on the configuration information during a subsequently performed radio sensing operation.

In some implementations of the method and apparatuses described herein, the UE receives information identifying capabilities of the network entity to perform the requested radio sensing operation.

In some implementations of the method and apparatuses described herein, the UE transmits the sensing request message to the network entity as an uplink control information element via a PUCCH, as a message via a PRACH, and/or as a message via a PUSCH.

In some implementations of the method and apparatuses described herein, the radio sensing operation is performed by the network entity to obtain information about a physical environment that includes the UE.

In some implementations of the method and apparatuses described herein, the radio sensing operation is performed by the network entity to obtain information about an object proximate to the UE.

### BRIEF DESCRIPTION OF THE DRAWINGS

FIG. 1 illustrates an example of a wireless communications system that supports performing radio sensing operations in accordance with aspects of the present disclosure.

FIGS. 2A-2B illustrate examples of block diagrams that support performing radio sensing operations between nodes of a wireless communications system in accordance with aspects of the present disclosure.

FIG. 3 illustrates a flowchart of a method that supports a network entity receiving a request to perform a radio sensing operation from a UE in accordance with aspects of the present disclosure.

FIG. 4 illustrates a flowchart of a method that supports a UE initiating a request for a radio sensing operation in accordance with aspects of the present disclosure.

FIG. 5 illustrates a flowchart of a method that supports a UE performing a radio sensing operation in accordance with aspects of the present disclosure.

FIG. 6 illustrates an example of a diagram that supports messaging between a UE and a network in response to a UE request for a radio sensing operation in accordance with aspects of the present disclosure.

FIG. 7 illustrates another example of a diagram that supports messaging between a UE and a network in response to a UE request for a radio sensing operation in accordance with aspects of the present disclosure.

FIG. 8 illustrates yet another example of a diagram that supports messaging between a UE and a network in response to a UE request for a radio sensing operation in accordance with aspects of the present disclosure.

FIG. 9 illustrates an example of a block diagram of a device that supports performing a radio sensing operation in a wireless communications system in accordance with aspects of the present disclosure.

### DETAILED DESCRIPTION

The technology is directed to messaging or signaling exchanges between user devices and network entities that facilitate the initiation, performance, and/or analysis of radio sensing operations within a wireless communications system. In some cases, problems associated with a UE within a network environment can arise due to objects (e.g., buildings) proximate to the UE and/or conditions within the physical environment (e.g., fog or inclement weather) that includes the UE. In such cases, the location of the UE can be difficult to discover, a clear path within the environment can be unknown, among other issues.

To alleviate such problems and/or provide additional uses for the UE (or an associated user), the systems and methods can enable a UE to initial or request a radio sending operation to detect or identify the objects or conditions within the environment and/or obtain information about the environment or objects proximate to the UE, among other benefits.

For example, a service or application active on the UE can utilize a feature or information obtained from the environment via a radio sensing operation. Thus, providing the UE with functionality to initiate, trigger, and/or request the radio sensing operation facilitates the UE to provide or support enhanced services to a user, as well as provide an associated wireless communications system with information about the UE and the environment within which the UE is located. The systems and methods can support or realize various use cases, including:
A use case or sensing scenario where the UE detects or identifies potential physical obstacles. For example, the UE, via an application or service, can provide walking/movement assistance for a user with low vision or for any user moving within a low visibility environment (e.g., a foggy or low light environment). As another example, the UE can detect or identify objects to detect objects in close proximity to a user, to monitor certain groups of users (e.g., children), and so on;
A use case or sensing scenario where the UE initiates a radio sensing operation to detect an object in its proximity to determine a relative positioning to the object, such that the location of the UE is identified when other location determination procedures fail;
A use case or sensing scenario where non-UE-assisted sensing methods fail to satisfy a required Quality of Service (QOS);
A use case or sensing scenario where the wireless communications system generates a picture or map of an environment and utilizes radio sensing to identify or detect an object/surrounding shape/gesture/composite within the environment;
A use case or sensing scenario where a loss of connectivity (e.g., a repeated sidelink (SL) link failure) between the UE and the wireless communications system triggers a blockage detection procedure; and so on.

Thus, UE initiated or requested radio sensing can facilitate the transfer of information between devices/entities to realize different use cases and/or alleviate wireless communications issues that arise from various conditions of a physical environment that includes a UE or UEs, among other benefits.

Aspects of the present disclosure are described in the context of a wireless communications system. Aspects of the present disclosure are further illustrated and described with reference to the following device diagrams and flowcharts that relate to UE initiated radio sending operations.

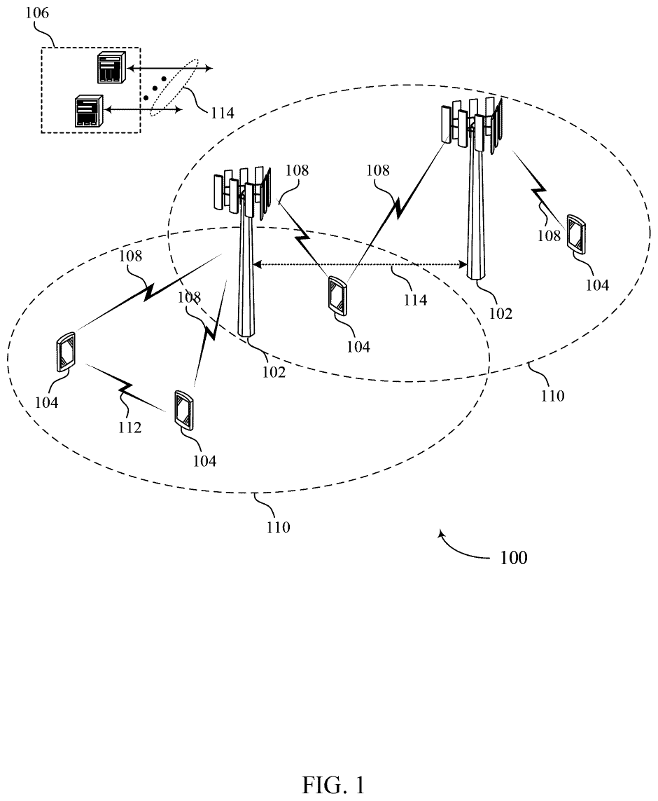

FIG. 1 illustrates an example of a wireless communications system 100 that supports performing radio sensing operations in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wirelessly communicate over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, a user device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

In some embodiments, the wireless communications system 100 supports the implementation of radio sensing operations initiated by the UEs 104 and performed by different nodes of the system 100, such as the base stations 102 and/or the UEs 104.

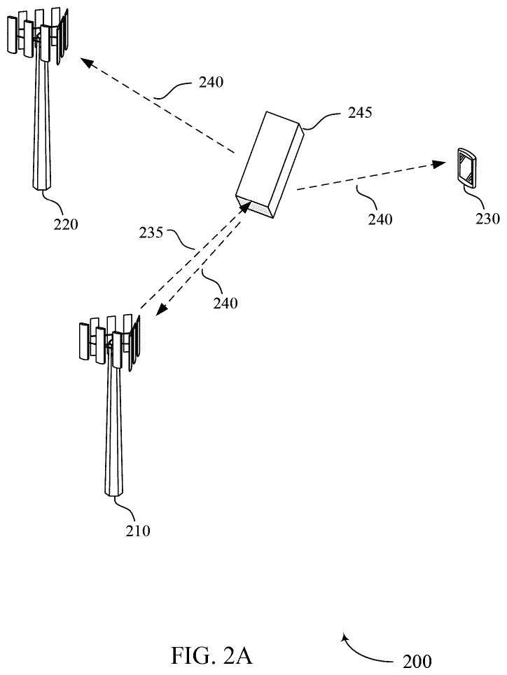

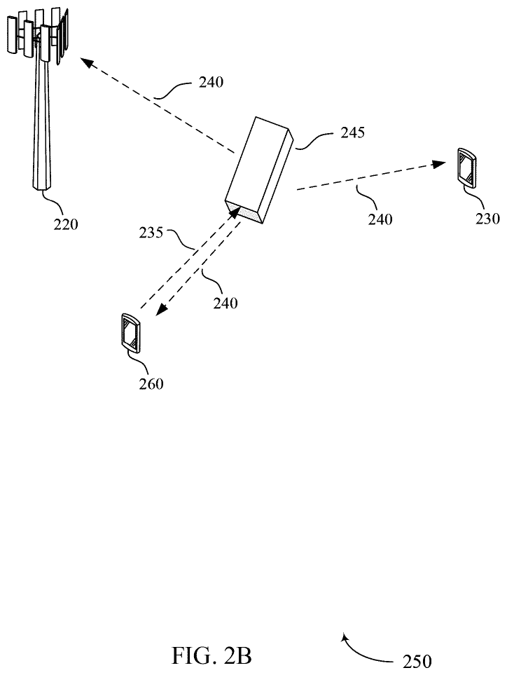

FIGS. 2A-2B illustrate examples of block diagrams that support performing radio sensing operations between nodes of a wireless communications system in accordance with aspects of the present disclosure. For example, FIG. 2A depicts a radio sensing operation 200 performed between a base station or other network entity 210 acting as a Tx node, and another base station 220 or a UE 230 acting as a Rx node.

As a first example of the radio sensing operation 200, the base station 210 transmits a sensing RS 235, which reflects off an object 245, resulting in a received RS 240 that is received by one or more network entities, such as the base station 220 or the UE 230. The network can indicate the sensing RS 235 to other (non-network) nodes or a subset of the UE nodes via Radio Resource Control (RRC) signaling, Physical Downlink Shared Channel (PDSCH) or Physical Downlink Control Channel (PDCCH)/Downlink Control Element (DCI) signaling or a group-common DCI.

For example, the network can signal the other resources via group-common DCI when the sensing RS 235 occupies resources similar to other physical channels, and hence, the indication of the sensing RS 235 is used to suppress the received RS 240 by nodes other than sensing Rx nodes, or used as an indication of sensing-dedicated resources where some of the physical channels are not be present/interfered with, or to mute transmissions taking place at the same resource to protect the sensing operation, for the purpose of interference measurements from the sensing Tx towards the UE nodes or other network devices, and/or where the sensing RS 235 is indicated to be re-used for other purposes (e.g., as an RS to track some CSI/environment information) by the UE devices.

In some cases, the assignment of the sensing RS 235 includes implicit information on the utilized waveform parameters (e.g., CP/guard-band length for the UE nodes, the type of the required sensing processing and reporting procedure, and so on).

As another example of the radio sensing operation 200, the base station 210 transmits and receives the sensing RS 235 (e.g., receives the RS 240), utilizing proper duplexing capability (e.g., full-duplex) to enable reception of the echoes/reflections transmitted by the same node. In some cases, the network indicates the utilized sensing RS 235 to other (non-network) nodes or a subset of the UE nodes via RRC signaling, PDSCH or PDCCH/DCI signaling or a group-common DCI.

In some cases, when the sensing RS 235 and some of the physical DL channels share the same resources, the adjustments on the physical DL channels are indicated to the relevant UE nodes (e.g., the use of additional DMRS (demodulation reference signal) patterns to support beam variations in case of the beam sweeping combined with the DL transmissions).

As another example of the radio sensing operation 200, the base station 210 transmits the sensing RS 235 and the UE 230 (or multiple UEs) receives the reflected RS 240. The network indicates (implicitly or via direct assignment) the UE 230 to operate as the sensing Rx, including (but not limited to) a definition of the sensing RS 235, a type of the sensing measurements, and/or a reporting strategy and reporting resources. The base station 210 can signal the UE 230 via RRC or dynamically via PDCCH/DCI, group-common DCI, and/or via a part of the sensing RS 235.

In some cases, the base station 210 communicates the information regarding the sensing RS 235 to other UE nodes (e.g., the base station 220), which are not a sensing Rx, using the various signaling methods described herein. Non-sensing-Rx UEs can utilize the sensing RS 235 information to comply with an updated waveform parameter due to sensing (e.g., the modification of CP/guard-bands during active sensing periods).

As another example, FIG. 2B depicts a radio sensing operation 250 performed between a UE 260 acting as a Tx node, and another base station 220 or a UE 230 acting as a Rx node.

As a first example of the radio sensing operation 250, the UE 260 transmits the sensing RS 235, which reflects the RS 240 to the base station. The network can indicate (implicitly or via direct assignment) the UE 260 to operate as the sensing Tx, including the definition of the sensing RS 235. The network signals the entities via RRC or dynamically via PDCCH/DCI, group-common DCI, and/or via a part of the sensing RS 235.

In some cases, the network communicates information regarding the sensing RS 235 shall be communicated to other UE nodes, which do not perform as a sensing Rx, using the signaling methods described herein. The non-Sensing Rx UEs can utilize the sensing RS 235 information for successive interference reduction, when the same resources are also used for DL or SL communications. Further, the non-Sensing Rx UEs can utilize the sensing RS 235 information to comply with an updated waveform parameter due to sensing (e.g., modification of CP/guard-bands during active sensing periods).

As another example of the radio sensing operation 250, the UE 260 transmits the sensing RS 235, which reflects off the object 245, and the RS 240 is received by another UE node, such as the UE 230. The network can indicate (implicitly or via direct assignment) the UE 230 to operate as the sensing Rx and the UE 260 to operate as the sensing Tx, as well as define the sensing RS 235, the type of the sensing measurements, and/or reporting strategy and reporting resources.

As described herein, the network signals the entities via RRC or dynamically via PDCCH/DCI, group-common DCI, and/or via a part of the sensing RS 235. In some cases, the network communicates information regarding the sensing RS 235 to other UE nodes, which do not perform as a sensing Rx, using the signaling described herein.

As another example of the radio sensing operation 250, the UE 260 transmits the sensing RS 235, which reflects off the object 245, and returns as the RS 240 to the UE 260. As described herein, the network utilizes various signaling methods to communicate information about the sensing RS 235 to the different entities, such as entities not performing the sensing Rx.

In some embodiments, the technology described herein provides messaging and/or signaling to enable or support the performance of radio sensing operations, as depicted in FIGS. 2A-2B and the associated examples.

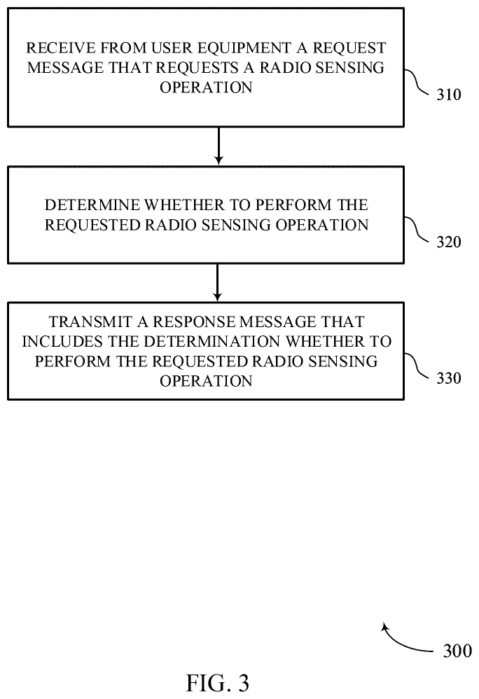

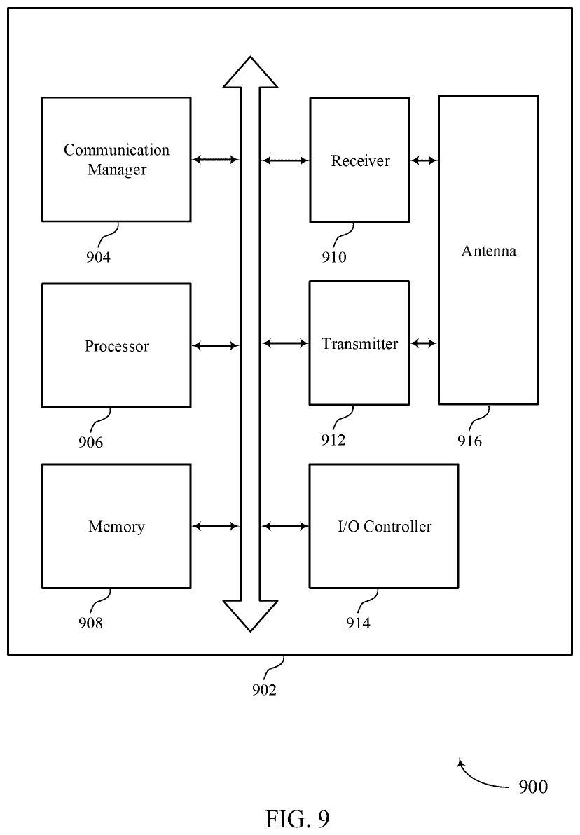

FIG. 3 illustrates a flowchart of a method 300 that supports a network entity receiving a request to perform a radio sensing operation from a UE in accordance with aspects of the present disclosure. The operations of the method 300 may be implemented by a device or its components as described herein. For example, the operations of the method 300 may be performed by the base station 102 as described with reference to FIG. 9. In some implementations, the device may execute a set of instructions to control the function elements of the device to perform the described functions. Additionally, or alternatively, the device may perform aspects of the described functions using special-purpose hardware.

At 310, the method 300 may include receiving from a UE, a request message including a request for the network entity to perform a radio sensing operation and a type of radio sensing operation to be performed by the network entity. The operations of 310 may be performed in accordance with examples as described herein. In some implementations, aspects of the operations of 310 may be performed by a device as described with reference to FIG. 1.

At 320, the method 300 may include determining whether to perform the requested radio sensing operation. The operations of 320 may be performed in accordance with examples as described herein. In some implementations, aspects of the operations of 320 may be performed by a device as described with reference to FIG. 1.

At 330, the method 300 may include transmitting, to the UE, a response message that includes an indication of the determination by the network entity to perform the requested radio sensing operation. The operations of 330 may be performed in accordance with examples as described herein. In some implementations, aspects of the operations of 330 may be performed by a device as described with reference to FIG. 1.

In some embodiments, the network entity receives the request message, which is sent by the UE to initiate a radio sensing operation. The request message can include information elements, which define the request, such as elements that indicate a type of radio sensing to perform. Further, the request message can include the type of information to be obtained via the radio sensing operation, the sensing scenarios where the UE can participate and/or supplement the radio sensing operation, and so on. Thus, the request message can include some or all of the following information elements.

In some cases, the request message can include or indicate the type of operation, such as by identifying the information to be obtained during the radio sensing operation. The type of operation can include a request for object/blockage detection, material/composite estimation, tracking or ranging of an object of interest, and/or estimating the speed of an object of interest. The request message can explicitly define the information to be obtained, such as to facilitate scheduling or a proper response determination by the network.

In some cases, the request message can include or indicate an object of interest, such as when the object of interest is previously known to the network and the UE is performing a continuous monitoring or tracking of the object. For example, when the object of interest is known to the network, the UE can include information identifying the object of interest, such as an object identifier number, or some object-defining parameters in the request message.

In other cases, the request message can include or indicate an area of interest for sensing/monitoring. The request message can include an area identifier (defining an area of interest), directional information (defining the direction of interest for sensing according to a local coordinate system known to the network), direction of interest information according to a global coordinate system, and/or a beam identifier where the area of interest is of a same direction as a known previous transmission for the network.

The request message can also include directional information and information defining the object and/or area of interest (e.g., object distance or distance margin to the UE or to a known entity by the network). The request message can define the area of interest in relation to a known object by the network, where additional information defining the object/area of interest in relation to the known object is included in the request message by the UE.

In some cases, the request message can include or indicate a QoS associated with the requested sending information. The QoS requirement can include:
Latency: where the request message indicates a tolerable latency requirement for the accomplishment of the requested radio sensing operation. The measurable time duration may be defined as the time-difference from the transmission of the request or reception of the request by the network, to the reception of the response from the network or reception of a sensing RS transmitted in response to the UE request, and/or accomplishment of the sensing procedure or reception/recovery of the intended sensing information by the UE;
Reliability/Accuracy: where the request message includes information about the accuracy of the obtained information, such as a tolerable probability of false alarm for detection within an object/area of interest, a required probability of detection for detection within an object/area of interest, a tolerable error measure on the envisioned parameter estimation, (e.g., an estimation of speed or distance of an object of interest), and so on;
Request importance: where the request message can include an indication of the significance of the requested information, such as a priority of the network for responding positively to the requested service (e.g., which is identified via a priority identifier/class for different types of requests);
Security/privacy: where the request message can include an indication of measures for protecting the envisioned (or, to be extracted) sensing information, and/or any informative propagation/reflection from the object/area of interest that may be used by an unauthorized third-party. For example, the request message can indicate a type of the security measure, such as object-of-interest sensing information protection, area of interest sensing information protection, requesting-UE identity protection together with the level of required security (e.g., as an integer number defining the required security level), and so on.

In some cases, the request message can include or indicate a task periodicity or time pattern, which indicates intervals for repeating the radio sensing operation. The request message can indicate the time intervals between radio sensing operations, a number of radio sensing operations to be performed, a total time duration or period for which radio sensing operations are to be repeated (e.g., to achieve one or more requested QoS parameters).

The request message can, in some cases, include or refer to a point in time in the future (e.g., an operation is to be performed after 1 second and before 2 seconds have elapsed with respect to a received response) and/or a validity period (e.g., a time duration for which the request is still valid).

In some cases, the request message can include or indicate capabilities of the UE to participate in the requested radio sensing operation. For example, the request message can indicate capabilities of the UE acting as a node for sensing the RS, acting as a node for transmitting the RS, acting as a node for processing a received RS, the available memory and computation resources for performing radio sensing operations, and so on.

In some cases, the request message can include or indicate a suggested sensing scenario or configuration, such as a resource pattern and type of the sensing RS (e.g., the time duration and density of the sensing RS in time and in frequency domains as well as the role of the requesting UE as a transmitter or a recipient of the sensing RS).

In some embodiments, the UE 104 transmits a repetition indication, combined with a reference to a previously performed radio sensing operation, as a request message for repeating a previously granted/performed radio sensing operation. The repetition indication can include an identification number for the previously performed radio sensing operation or to an n-th previously performed radio sensing operation. In some cases, the request message refers to the n-th previously sent request message, which may or may not have been granted by the network entity.

In some embodiments, the request message can refer to a previously performed radio sensing operation or a previously sent request message with some additional information for modification. For example, the request message indicates a previously sent, but not-granted, request message, along with a different level of sensing QoS (e.g., a lower required range resolution). As another example, the request message indicates a previously sent request, along with an updated sensing duration or time period.

In some embodiments, the request message an include a subset of the information elements described herein. The request message can embed the information via an index from a codebook, where the codebook defines different possible values for the information elements associated with the requested radio sensing operation.

In some cases, one or multiple codebooks for defining a radio sensing operation request are available, where each codebook includes possible values for one or a subset of the information elements associated with the request. The codebooks can define information elements above in accordance with use cases that may be relevant for applications or services provided by the UE 104.

These information elements within the request message can include default values, unless the value of the information element is explicitly or implicitly defined in the request message. In some cases, the network can transfer possible/supported codebook entries to the UE, such as upon indication of a relevant UE capability or a service request. An example codebook including different possible sensing request types and QoS are depicted in Tables 1 and 2 below.

TABLE 1
an example codebook structure to define a request message

| | | | Object/area | UE | |
|---|---|---|---|---|---|
| Request | Sensing | Information | of interest | sensing | Priority |
| Index | QoS | type | ID | capability | class |
| 0 | 1 | 1 | 1 | 1 | 1 |
| 1 | 2 | 1 | 1 | 2 | 2 |
| . . . | | | | | |

TABLE 2
an example codebook structure to define a requested sensing QoS

| | | | Min. | Range/ | Security/ | |
|---|---|---|---|---|---|---|
| QoS | Min. Range | Max. | P-D, Max | Velocity | privacy | |
| Index | and Velocity | Range/Velocity | P-FA | Resolution | requirements | Latency |
| 0 | 10 m and 0 m/sec | 30 m and 20 m/sec | 0.95 and 0.1 | — | — | <100 msec |
| 1 | 10 m and 20 m/sec | 30 m and 50 m/sec | — | 1 m and 1 m/sec | — | <20 msec |
| . . . | | | | | | |

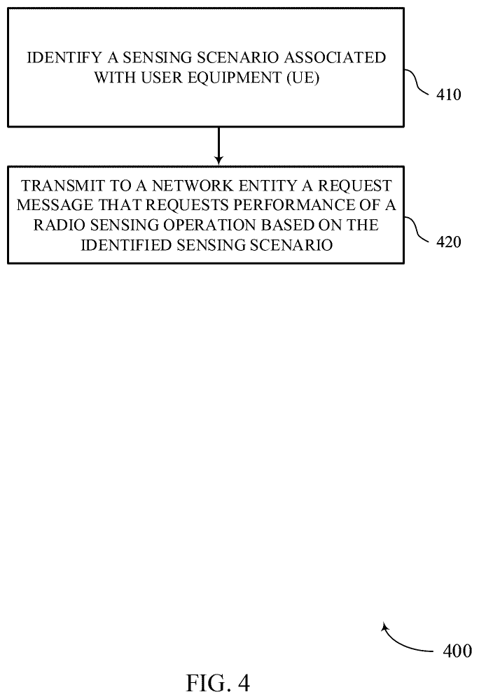

FIG. 4 illustrates a flowchart of a method 400 that supports a UE initiating a request for a radio sensing operation in accordance with aspects of the present disclosure. The operations of the method 400 may be implemented by a device or its components as described herein. For example, the operations of the method 400 may be performed by the UE 104 as described with reference to FIG. 9. In some implementations, the device may execute a set of instructions to control the function elements of the device to perform the described functions. Additionally, or alternatively, the device may perform aspects of the described functions using special-purpose hardware.

At 410, the method 400 may include identifying a sensing scenario associated with the UE. The operations of 410 may be performed in accordance with examples as described herein. In some implementations, aspects of the operations of 410 may be performed by a device as described with reference to FIG. 1.

At 420, the method 400 may include transmitting to a network entity a request message that requests performance of a radio sensing operation based on the identified sensing scenario. For example, the request message can include some or all of the information elements described herein. The operations of 410 may be performed in accordance with examples as described herein. In some implementations, aspects of the operations of 410 may be performed by a device as described with reference to FIG. 1.

In some embodiments, the response message, transmitted from the network entity to the requesting UE 104, can include information elements that define a network reaction, decision, and/or determination to the request message. For example, the response message can grant the radio sensing operation request, deny the radio sensing operation request, or qualify the determination whether to performing the requested radio sensing operation.

Thus, the network entity can transmit a response message to the UE that includes an indication of a request-acceptance or rejection, a role of the requesting UE in a granted radio sensing operation, information identifying a granted radio sensing scenario or operation parameters, and so on.

The response message, as described herein, includes a determination whether to accept or reject the request to perform the radio sensing operation. The response can include the following determinations or decisions:
Request granted: The requested radio sensing operation by the UE is granted where a known sensing scenario, such as a previously configured scenario or a suggested sensing scenario/configuration, will be used, as indicated by the request message;
Request granted with configuration: The radio sensing operation requested by the UE is granted, and the response message included additional information to identify the exact sensing scenario/resources and the expected role of the requesting UE during the radio sensing operation.
Request granted with modification: The requested radio sensing operation by the UE is granted, with modifications to the requested radio sensing operation. For example, the response message can indicate that some requested features (e.g., a type of UE involvement, suggested sensing RS pattern, requested timing, and so on) may not be employed. In some cases, the requesting UE can accept the modification prior to the start of the radio sensing operation. In some cases, the network entity performs the radio sensing operation based on the modified granted request, without further acceptance by the requesting UE and/or when a non-agreement message is not sent by the requesting UE to indicate the rejection of the request modification;
Request granted but queued: The requested radio sensing operation is granted and postponed or scheduled to a later time when specific conditions are met. For example, the network entity can inform the UE of the time and/or resources/configuration of the radio sensing operation. In some cases, the response message includes an indication to the UE to send a termination request of the queued request when the UE no longer has use for the requested radio sensing operation (e.g., due to a long waiting time and/or change in the sensing conditions of the UE), so the network entity can terminate/release the queued response and the related resources. In some cases, the request message can indicate an allowed waiting time for a queued response;
Rejected: The requested radio sensing operation is rejected. The response message includes no additional information. The UE may re-transmit the request message at any time; or
Rejected, with explanation: The requested radio sensing operation is rejected, due to the reasons included in the response message or in a message subsequently transmitted to the requesting UE. The indicated reasons for rejection can include: lack of sufficient resources for the intended radio sensing, lack of permission to enable the requesting UE with the reception of the intended information with the requested QoS, lack of capability in the UE/network for the requested radio sensing operation, and so on. In some cases, the decision to reject the request may accompany a not-supported information, indicating the sensing request was not considered. In such cases, information identifying a time-duration or a condition (e.g., UE location, cell ID) can indicate the condition for which the sensing request was or may not be supported. Once the indicated condition/limitation is removed, the UE can re-transmit the request.

In some embodiments, the response message includes information that identifies information types that are allowed or approved for radio sensing operations. For example, the response message can indicate a type of the intended or allowed information to be obtained, such as when extracting other information types are not permitted and/or facilitated by the network via the envisioned or requested radio sensing operation. Types of intended or allowed information can include an indication for desired object/blockage detection, material/composite estimation, tracking or ranging of an object of interest, estimating the speed of an object of interest, and so on. The response message can indicate such information types as not approved or not allowed.

In some embodiments, the response message includes information regarding the objects, directions, and/or direction range of location/area-of interest information for which a radio sensing operation is granted. For example, when an object of interest is known to the UE, the network entity can include an object identifier number, or some object-defining parameters, in the response message. In some cases, the response message can include information regarding the area of interest targeted for sensing/monitoring, such as an area identifier (defining the area of interest) directional information (defining the direction of interest for sensing according to a local coordinate system known to UE), a direction of interest information according to a global coordinate system, or a UE beam identifier where the area of interest is of the same direction as a known previous transmission for the UE. The response message can accompany the directional information with further information defining the object and/or area of interest (e.g., object distance or distance margin to the UE or to an entity known by the UE). For example, the area of interest is defined in relation to an object known by the UE.

In some embodiments, the response message includes the envisioned QoS or allowed QoS for the requested sensing information, such as those described herein.

In some embodiments, the response message can include a time pattern of the granted radio sensing operation. For example, when the radio sensing operation is requested by the UE for multiple instances of time with some distance/periodicity and/or number of repetitions, the response message includes the granted instances of the radio sensing, indicating all or a subset of the requested instances where the radio sensing is granted.

In some cases, the granted information includes the time information when the sensing is to be performed, the periodicity or time-interval between two granted sensing operations, and/or the number of the granted radio sensing operations or a total time duration for which the sensing operations are repeated. In some embodiments, the granted information can refer to a time-point in the future (e.g., the radio sensing operation is granted to be performed after 1 second), and the response message can include the additional configuration information, or the additional configuration information can be in a subsequently transmitted response message.

In some embodiments, the response message can include information regarding the granted sensing configuration and/or scenario, including the resource pattern and type of the sensing RS (e.g., the time duration and density of the sensing RS in time and in frequency domains as well as the role of the requesting UE, as a transmitter or a recipient of the sensing RS, and the type of the reporting from the requesting UE to the network, upon accomplishment and/or during the sensing measurements and/or computations).

In some cases, one or multiple codebooks for defining a radio sensing operation request are available, where each codebook includes possible values for one or a subset of the information elements associated with the request. The codebooks can define information elements above in accordance with use cases that may be relevant for applications or services provided by the network entity 102.

These information elements within the request message can include default values, unless the value of the information element is explicitly or implicitly defined in the request message. In some cases, the network can transfer possible/supported codebook entries to the UE, such as upon indication of a relevant UE capability or a service request. An example codebook that defines information in a response message is depicted in Table 3 below.

TABLE 3
an example codebook structure to define the network response
to a UE request for a radio sensing operation

| | | | | Sensing | |
|---|---|---|---|---|---|
| | | | | Scenario: | |
| Response | | Sensing | Sensing | additional | |
| type | Request | Scenario: | Scenario: | information | Priority |
| Index | grant | RS resource | UE role | elements | class |
| 0 | 3 | 1 | 1 | 1 | 1 |
| 1 | 2 | 1 | 1 | 2 | 2 |
| . . . | | | | | |

In some embodiments, the UE 104 transmits the request message to another UE, or a group of UEs when the sensing operation is expected to be done without network involvement.

In some embodiments, the network entity does not send a response message, and thus an indication of a request rejection is not sent by the network. The UE may implicitly determine that the request was rejected when a response is not received by the UE in a pre-configured time-window by the network. In some embodiments, the response message does not include an explicit grant/accept indication or an explicit configuration of the sensing scenario and sensing RS resources.

Instead, upon an acceptance of the UE sensing request, the network entity transmits the sensing RS with the suggested resources/configurations requested by the UE. Upon transmission of the request and the suggested sensing RS resources by the UE, the requesting UE monitors the suggested sensing RS resources for a possible transmission of sensing RS by the network. In some cases, the network may transmit a configuration message for the radio sensing operation when the requested/suggested sensing RS resources by the requesting UE are not accepted. In other cases, the information elements within the response message are defined in relation to the requested values in the response message, or in relation to the index value of the sensing scenario-defining parameters included in the request message.

Once a request is accepted or granted, the network entity can perform the requested radio sensing operation. In some cases, the sensing procedures and/or associated messaging flows depend on the use case, such as the type of radio sending operation, and/or the role of the network entity.

For example, when the expected sensing information (e.g., results of a radio sensing operation) is applied as a service/input to an application managed/configured by the UE, the network assists the application by performing the sensing operation according to the UE request.

As another example, when the expected sensing information is configured by the network, the UE assists the application by triggering and potentially participating in the radio sensing operation. The UE can receive configuration information and generate a measurement report, to be sent to the network entity, that incudes sensing information obtained when performing a radio sensing operation to assist the network.

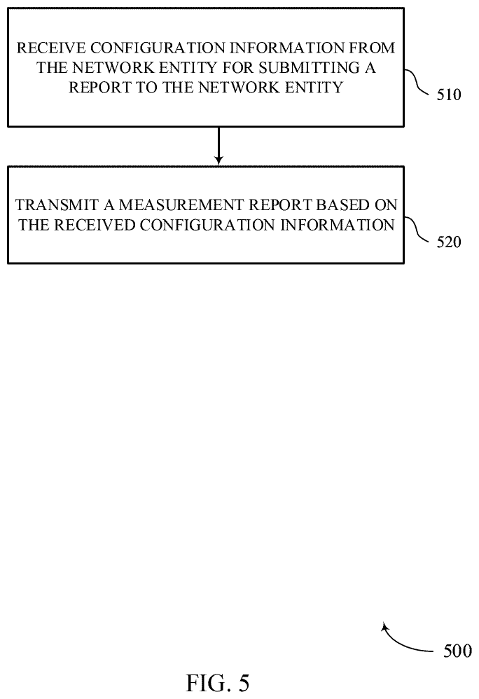

FIG. 5 illustrates a flowchart of a method 500 that supports a UE performing a radio sensing operation in accordance with aspects of the present disclosure. The operations of the method 500 may be implemented by a device or its components as described herein. For example, the operations of the method 500 may be performed by the UE 104 as described with reference to FIG. 9. In some implementations, the device may execute a set of instructions to control the function elements of the device to perform the described functions. Additionally, or alternatively, the device may perform aspects of the described functions using special-purpose hardware.

At 510, the method 500 may include receiving configuration information from the network entity for submitting a report to the network entity. The operations of 510 may be performed in accordance with examples as described herein. In some implementations, aspects of the operations of 510 may be performed by a device as described with reference to FIG. 1.

At 520, the method 500 may include transmitting a measurement report based on the received configuration information. The operations of 510 may be performed in accordance with examples as described herein. In some implementations, aspects of the operations of 510 may be performed by a device as described with reference to FIG. 1.

As described herein, a radio sensing operation can be performed based on a request message sent by the UE 104 and based on the network response to the request message, where the UE triggering strategy/policy, as well as the content of the request message, is autonomously determined by the UE.

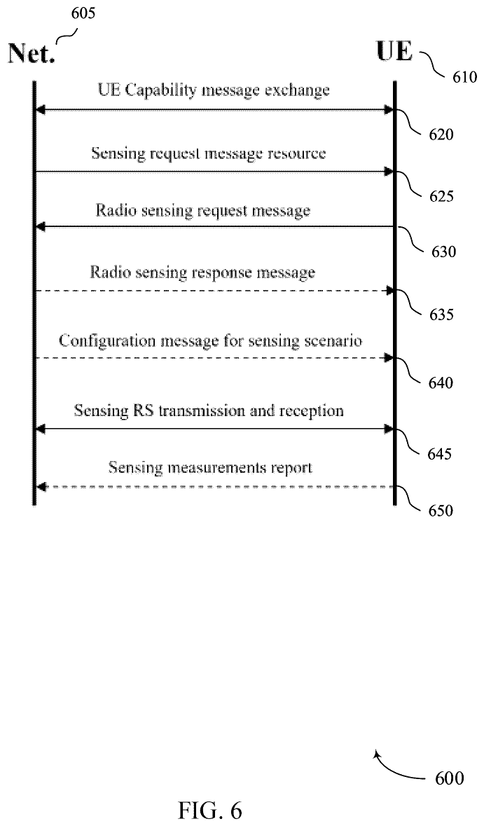

FIG. 6 illustrates an example of a diagram 600 that supports messaging between a UE 620 and a network 605 in response to a UE request for a radio sensing operation in accordance with aspects of the present disclosure.

The UE 610 informs the network 605 via a UE capability message exchange 620 of the UE capability/possibility to send a sensing request, either as a response to a network request for such capability information (e.g., via a UE capability information element) or autonomously. For example, the capability message 620 can implicitly indicate that the UE 610 is running a use-case application which may trigger such a request.

In some embodiments, the UE capability information for sensing includes information indicating the UE 610 as a sensing operation initiator via the sensing request, as a sensing Rx, as a sensing Tx, and/or as both an Rx and a Tx. The network 605 may send a sensing request message resource 625 to indicate to the UE 610 the relevant UL resources for the transmission of the UE sensing request. For example, the network 605 may indicate that the sensing service, in general or specific to the UE and/or specific use case, is not available at the serving cell and/or at the current time.

In some embodiments, as part of the UE/network capability message exchange 620, the availability of radio sensing operation support by the network 605 is indicated to the UE 610. The message exchange 620 can include supported information elements to be included in a request message 630 sent by the requesting UE 610, indicating the supported types of sensing information types, sensing QoS scenarios, the supported role of the network 605, for the envisioned radio sensing operation, and so on. For example, the network capability for supporting a radio sensing operation may depend on the serving cell and operating frequency band, the type of UE subscription, the UE location and/or the UE capability.

In response to the request message 630, the network can send a response message 635 to the UE 610 that indicates a decision or determination whether to grant or deny the radio sensing operation request.

In some embodiments, only a subset of the messages presented in FIG. 6 are exchanged between the network 605 and the UE 610. For example, upon rejection of the request message 630, the subsequent messages are not exchanged. The network 604 can indicate a reject or deny decision by not communicating a response message within a given/known time window. In some cases, the network 606 can send part of the response message 635 at one time, (e.g., containing a grant/rejection indication), and send another part of the message 635 at another time (e.g., a detailed sensing scenario configuration 640 and the role of the requesting UE in the sensing operation, the sensing resources and sensing RS configurations, and/or the condition/type of the granted sensing operations).

In some embodiments, when the request message 630 includes a request for multiple radio sensing operations, or when the same UE transmits multiple request messages corresponding to the same or multiple requested sensing operations (e.g., sensing operations at different time instances and/or different angle/object locations or different target QoS defined via the same request message), the grant/rejection indication in each or a subset of the requested radio sensing operations and the configuration information of the granted sensing operations may be transmitted via a shared response message and/or separate response messages transmitted at different times corresponding to different requests and/or response message fields.

In some embodiments, all information elements of the response message 635 are accompanied within the same message. In some embodiments, transmission 645 of the sensing RS by the network 605 or a third-party node starts at the same symbol or slot where the response message 635 is received by the UE 610.

In some embodiments, the configuration of the sensing operation, including the transmission and reception of the sensing RS and/or the subsequent measurement and reporting, is transparent to the requesting UE 610. Thus, the response messages do not include any sensing scenario configuration, and the information obtained from the requested radio sensing operation by the UE 610 is obtained by the network 604 and reported to the UE (e.g., when UE needs sensing information but is not willing/capable to participate in the sensing operation). For example, when the requested information is already available to the network 604 or is obtained via other sensing means (e.g., 3GPP/non-3GPP RF sensors or non-RF sensors), the requested information is provided to the requesting UE 610 without performing or configuring a dedicated radio sensing operation.

In some cases, the network 605 configures and/or performs the radio sensing operation 645 in response to multiple related requests by the same or multiple requesting UEs, when the obtained sensing information is relevant to both requests, such as when the same object is to be monitored as a result of sensing requests sent via multiple UEs. For example, when the requesting UE 610 is configured to act as the sensing Rx node, the UE 610 transmit the obtained measurements or the extracted sensing information to the network 605 via a sensing measurement report 650.

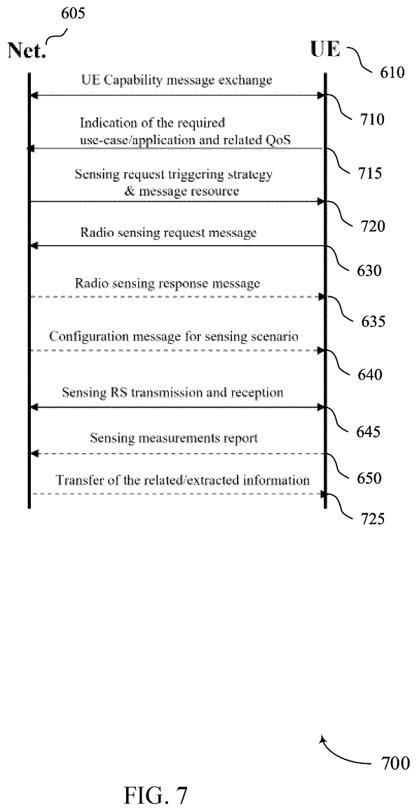

In some embodiments, the UE 610 determines the transmission of sensing requests and/or the type of the requested radio sensing operation without prior assistance/recommendation from the network 605. However, in some embodiments, the UE 610 informs the network 605 of an intended use case or associated higher-level requirements, such as a request for obstacle monitoring by the UE 610 or presence of an accompanying person, a breathing/heartrate monitoring of an accompanying person with an indicated sensitivity, and so on. FIG. 7 illustrates another example of a diagram 700 that supports messaging between the UE 610 and the network 605 in response to a UE request for a radio sensing operation in accordance with aspects of the present disclosure.

Thus, after a UE capability message exchange 710, the UE 610 transmits an indication 715 of a type of the intended use case/application/QoS, and the network 605 provides the UE 610 with a recommendation message 720 containing a triggering strategy, such as a threshold on the UE estimation of a parameter, or a function computed at the UE 610 from the input parameters related to the indicated use case. For example, upon an indicate of a requested target KPI or use case from the UE 610, the network 605 provides a recommended triggering strategy and/or type of a request or message format.

After exchange the request message 630 and the response messages 635 and/or 640, the entities perform the radio sensing operation 645. In some cases, the UE 610 may adopt or discard the network recommendation 720 based on the available local data at the UE 610. In some cases, the network 605 further assists the UE 610 via additional information available at the network side, obtained via other sensing operations or via other information-generating mechanisms (e.g., non-RF sensors or other RF sensors), when available, by aggregating the sensing measurements to the prior available data and sending the extracted information 725 to the UE 610.

In some cases, the network 605 transmits the response message 635 to the requesting UE 610 from another UE, such as when the radio sensing operation is performed via an SL PC5 interface. In these cases, the sensing request and response process can be performed without network involvement, such as between UEs.

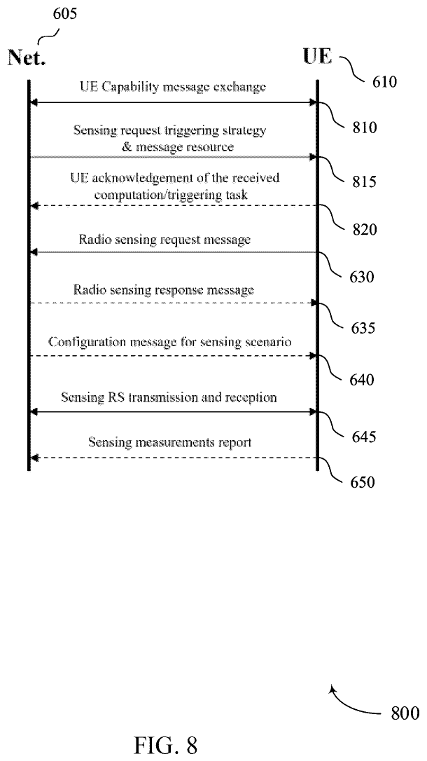

In some embodiments, a radio sensing operation is performed because of an initial UE request and according to a network response to the requesting UE. For example, the network 605 determines the UE triggering strategy/policy content of the request message 630, the sensing scenario, the sensing RS pattern, and/or the role of the requesting UE in the sensing operation. FIG. 8 illustrates another example of a diagram 800 that supports messaging between the UE 610 and the network 605 in response to a UE request for a radio sensing operation in accordance with aspects of the present disclosure.

As depicted, upon exchange of the UE capability information 810, the network 605 configures a specific task 815 to be performed by the UE 610, for which the UE 610 may send the request message 820, after sending an acknowledgement message 815, according to a strategy defined by the network 605. For example, the network 605 can indicate to the UE 610 to monitor a specific environment related feature (e.g., a presence of an object at an area of interest, object composite, shape, gesture, position/range, or some health-care related metric, such as breathing rate or heart rate). The UE capability can include the sensing capability via non-3GPP RF or non-RF sensors, where some of the obtained sensing information via the sensors can be used in a task indicated by the network 605 and/or be reported to the network 605. Thus, the UE 610 transmits the request message 630 containing a sensing request that is based on a strategy defined by the network 605.

Upon the indication of a task to the UE 610, such as via the message 815, the UE 610, via the acknowledgement message 815, may indicate that the requested task by the network is not feasible at the time or may indicate to agree with the requested task. In some cases, when the requesting UE 610 acts as a sensing Rx during the requested radio sensing operation, the sensing measurements, and the related computation or data aggregation with the other sensing entities available to the UE 610, is communicated to the network 605.

In some cases, messages as depicted in FIG. 8 are sent in a message sequence after transmission of any prior message and/or only after reception of an acknowledgement by a receiver of a previously sent message.

In some embodiments, when the UE 610 is capable of full-duplex (FD) operation or when the UE 610 does not require assistance from the network 605 for the requested radio sensing operation, the request message 630 may include an indication of the FD mode, the indication of the feasible resource pattern, such as bandwidth or time occasions or beam/direction/spatial filter information at the UE 610. In some cases, the network response message 635 includes a specific permission to perform full-duplex sensing, which may include a maximum transmit power for performing sensing, a dedicated frequency and time resources to perform FD sensing at the UE 610, the non-dedicated resources where FD sensing at the UE 610 is permitted, and/or maximum transmit power at a specific direction/beam to be respected when the UE 610 applies FD sensing. The network 605 can define conditional permission for FD sensing at the UE 610.

In some cases, the network 605 transmits the response message 635 to the requesting UE 610 from another UE, such as when the radio sensing operation is performed via an SL PC5 interface. In these cases, the sensing request and response process can be performed without network involvement, such as between UEs.

In some embodiments, the network 605 and/or the UE 610 utilize known UL and DL physical channels to transmit data and/or control information within the network to convey the messages to establish a radio sensing operation initiated by a UE request. For example, the UE capability for transmitting a request message is exchanged as a capability information element via an envisioned RRC message field. The network support/service availability for a radio sensing operation and/or information on the possible radio sensing operations can be communicated via a broadcast message (e.g., via a system information block, or SIB) or via a multi-cast control information element, (e.g., Downlink Control Information (DCI) with Cyclic Redundancy Check (CRC) scrambled via a group common Radio Network Temporary Identifier (RNTI)).

In some embodiments, the information regarding the configuration of the request message (e.g., a supported codebook, message type and/or the resources for the message transmission) is transmitted to the UE 610 dynamically, via a DCI or a group common DCI, semi-statically via RRC messaging, or via a broadcast message (e.g., SIB).

In some embodiments, the request message is communicated to the network 605 as an uplink control information element, such as by using a specific PUCCH format for sensing or bitfields in UCI (Uplink Control Information) over PUCCH/PUSCH. In response to the request message, the response message and the associated configuration information elements are transmitted to the UE 610 via a DL control channel (e.g., dynamically via PDCCH using specific DCI format for sensing, specific bitfields in one of the DL DCIs, and/or as a semi-persistent configuration via the RRC signaling.

In some embodiments, when the request message and the response message are exchanged among the UEs, the SL PC5 interface is used for message exchange. In some embodiments, a SCI within PSCCH is defined to carry the request message, and/or a SCI within PSCCH is defined to carry the response message and/or the sensing scenario configuration, in response to the received request message.

FIG. 9 illustrates an example of a block diagram 900 of a device 902, which supports performing radio sensing operations for a wireless communications system. The device 902 may be an example of the base station 102, as described herein. The device 902 may support wireless communication with one or more base stations 102, UEs 104, or any combination thereof. The device 902 may include components for bi-directional communications including components for transmitting and receiving communications, such as a communications manager 904, a processor 906, a memory 908, a receiver 910, transmitter 912, and an I/O controller 914. These components may be in electronic communication or otherwise coupled (e.g., operatively, communicatively, functionally, electronically, electrically) via one or more interfaces (e.g., buses).

The communications manager 904, the receiver 910, the transmitter 912, or various combinations thereof or various components thereof may be examples of means for performing various aspects of the present disclosure as described herein. For example, the communications manager 904, the receiver 910, the transmitter 912, or various combinations or components thereof may support a method for performing one or more of the functions described herein.

In some implementations, the communications manager 904, the receiver 910, the transmitter 912, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 906 and the memory 908 coupled with the processor 906 may be configured to perform one or more of the functions described herein (e.g., by executing, by the processor 906, instructions stored in the memory 908).

Additionally or alternatively, in some implementations, the communications manager 904, the receiver 910, the transmitter 912, or various combinations or components thereof may be implemented in code (e.g., as communications management software or firmware) executed by the processor 906. If implemented in code executed by the processor 906, the functions of the communications manager 904, the receiver 910, the transmitter 912, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 904 may be configured to perform various operations (e.g., receiving, monitoring, transmitting) using or otherwise in cooperation with the receiver 910, the transmitter 912, or both. For example, the communications manager 904 may receive information from the receiver 910, send information to the transmitter 912, or be integrated in combination with the receiver 910, the transmitter 912, or both to receive information, transmit information, or perform various other operations as described herein. Although the communications manager 904 is illustrated as a separate component, in some implementations, one or more functions described with reference to the communications manager 904 may be supported by or performed by the processor 906, the memory 908, or any combination thereof. For example, the memory 908 may store code, which may include instructions executable by the processor 906 to cause the device 902 to perform various aspects of the present disclosure as described herein, or the processor 906 and the memory 908 may be otherwise configured to perform or support such operations.

For example, the communications manager 904 may support wireless communication at a first device (e.g., the device 902) in accordance with examples as disclosed herein. The communications manager 904 may be configured as or otherwise support a means for performing radio sensing operations. For example, the communications manager 904 can: receive, from a UE, a request message including a request for the network entity to perform a radio sensing operation and a type of radio sensing operation to be performed by the network entity, determine whether to perform the requested radio sensing operation, and transmit, to the UE, a response message that includes an indication of the determination by the network entity to perform the requested radio sensing operation.

The processor 906 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 906 may be configured to operate a memory array using a memory controller. In some other implementations, a memory controller may be integrated into the processor 906. The processor 906 may be configured to execute computer-readable instructions stored in a memory (e.g., the memory 908) to cause the device 902 to perform various functions of the present disclosure.

The memory 908 may include random access memory (RAM) and read-only memory (ROM). The memory 908 may store computer-readable, computer-executable code including instructions that, when executed by the processor 906 cause the device 902 to perform various functions described herein. The code may be stored in a non-transitory computer-readable medium such as system memory or another type of memory. In some implementations, the code may not be directly executable by the processor 906 but may cause a computer (e.g., when compiled and executed) to perform functions described herein. In some implementations, the memory 908 may include, among other things, a basic I/O system (BIOS) which may control basic hardware or software operation such as the interaction with peripheral components or devices.

The I/O controller 914 may manage input and output signals for the device 902. The I/O controller 914 may also manage peripherals not integrated into the device 902. In some implementations, the I/O controller 914 may represent a physical connection or port to an external peripheral. In some implementations, the I/O controller 914 may utilize an operating system such as iOS®, ANDROID®, MS-DOS®, MS-WINDOWS®, OS/2®, UNIX®, LINUX®, or another known operating system. In some implementations, the I/O controller 914 may be implemented as part of a processor, such as the processor 906. In some implementations, a user may interact with the device 902 via the I/O controller 914 or via hardware components controlled by the I/O controller 914.

In some implementations, the device 902 may include a single antenna 916. However, in some other implementations, the device 902 may have more than one antenna 916, which may be capable of concurrently transmitting or receiving multiple wireless transmissions. The receiver 910 and the transmitter 912 may communicate bi-directionally, via the one or more antennas 916, wired, or wireless links as described herein. For example, the receiver 910 and the transmitter 912 may represent a wireless transceiver and may communicate bi-directionally with another wireless transceiver. The transceiver may also include a modem to modulate the packets, to provide the modulated packets to one or more antennas 916 for transmission, and to demodulate packets received from the one or more antennas 916.

In addition to supporting wireless communication at a first device, such as the base station 102, the communications manager 904, when implemented as part of the UE 104, can support wireless communication at a second device (e.g., the sensor node 204) in accordance with examples as disclosed herein. The communications manager 904 may be configured as or otherwise support a means for initiating a radio sensing operation. For example, the communications manager 904 can: identify a sensing scenario associated with the UE or an environment that includes the UE and transmit, to a network entity, a request message indicates a request for the network entity to perform a radio sensing operation on behalf of the UE and a type of radio sensing operation to be performed by the network entity.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity for wireless communication, comprising:
at least one memory
at least one processor coupled with the at least one memory and configured to cause the network entity to:
receive, from a user equipment (UE), a request message including a request for the network entity to perform a radio sensing operation and a type of radio sensing operation to be performed by the network entity;
determine whether to perform the requested radio sensing operation; and
transmit, to the UE, a response message that includes an indication of the determination by the network entity to perform the requested radio sensing operation.

2. The network entity of claim 1, wherein the request message includes one or more of:
first information that identifies an object or area of interest targeted by the requested radio sensing operation; or
second information that identifies an environment within which the requested radio sensing operation is to be performed by the network entity.

3. The network entity of claim 1, wherein the at least one processor is further configured to cause the network entity to transmit configuration information to the UE that includes one or more of:
a set of time resources, frequency resources, or beam resources for transmission of the sensing request message;
a set of criteria for transmission of the sensing request message;
a message type for the sensing request message; or.

4. The network entity of claim 1, wherein the response message includes:
an indication that the request is granted by the network entity and that the radio sensing operation to be performed by the network entity is different than a requested radio sensing operation by the UE;
an indication that the request is granted by the network entity and the radio sensing operation is to be performed at a time period different than a requested time period;
an indication that the request has been rejected by the network entity along with information identifying one or more factors for the rejection;
an indication that the request is granted by the network entity, including a periodicity or time-pattern for performing the radio sensing operation;
an indication the request is granted by the network entity including a granted radio sensing scenario for the UE;
an indication of an object or area of interest to be sensed during the requested radio sensing operation;
an indication of a quality of service (QOS) for sensing information that results from the radio sensing operation; or
combinations thereof.

5. The network entity of claim 1, wherein, to transmit the response message, the at least one processor is configured to cause the network entity to:
transmit a first message that indicates a decision of whether the requested radio sensing operation is to be performed by the network entity; and
transmit a second message that indicates information associated with the radio sensing operation.

6. The network entity of claim 1, wherein the at least one processor is further configured to cause the network entity to transmit sensing information to the UE based on the performed radio sensing operation.

7. The network entity of claim 1, wherein the request message is received as an uplink control information element via a Physical Uplink Control Channel (PUCCH), as a message via a Physical Random Access Channel (PRACH) or a Physical Uplink Shared Channel (PUSCH), or a combination thereof.

8. The network entity of claim 1, wherein the response message is transmitted dynamically via a Physical Downlink Control Channel (PDCCH) or semi-persistently via a Radio Resource Control (RRC) message.

9. The network entity of claim 1, wherein the response message includes one or more information elements indicated by one or more indices of a codebook, wherein the codebook identifying identifies parameter combinations for the response message.

10. The network entity of claim 1, wherein the response message includes one or more information elements indicated by one or more indices of a codebook of the network entity, and wherein the codebook identifies capability information of the network entity to perform the radio sensing operation.

11. The network entity of claim 1, wherein the at least one processor is further configured to cause the network entity to transmit capability information, which identifies capabilities of the network entity to perform the radio sensing operation, via a broadcast message or a multicast message.

12. The network entity of claim 1, wherein the radio sensing operation is performed by the network entity to obtain information about a physical environment that includes the UE.

13. The network entity of claim 1, wherein the radio sensing operation is performed by the network entity to obtain information about an object proximate to the UE.

14. A method performed by a network entity, the method comprising:
receiving, from a user equipment (UE), a request message including a request for the network entity to perform a radio sensing operation and a type of radio sensing operation to be performed by the network entity;
determining whether to perform the requested radio sensing operation; and
transmitting, to the UE, a response message that includes an indication of the determination by the network entity to perform the requested radio sensing operation.

15. (canceled)

16. A user equipment (UE) for wireless communication, comprising:
at least one memory; and
at least one processor coupled with the at least one memory and configured to cause the UE to:
identify a sensing scenario associated with the UE or an environment that includes the UE; and
transmit, to a network entity, a request message indicates a request for the network entity to perform a radio sensing operation on behalf of the UE and a type of radio sensing operation to be performed by the network entity.

17. The UE of claim 16, wherein the at least one processor is further configured to cause the UE to:
receive a response message that includes a determination regarding the network entity performing the requested radio sensing operation.

18. The UE of claim 16, wherein the request message includes an indication of a requested sensing task periodicity, a requested time pattern, a requested validity period, or combinations thereof.

19. The UE of claim 16, wherein the at least one processor is further configured to cause the UE to:
receive configuration information associated with the UE transmitting a report during a performed sensing operation; and
transmit a sensing measurement report based on the configuration information during a subsequently performed radio sensing operation.

20. The user equipment of claim 16, wherein the UE transmits the sensing request message to the network entity as an uplink control information element via a Physical Uplink Control Channel (PUCCH), as a message via a Physical Random Access Channel (PRACH), or a Physical Uplink Shared Channel (PUSCH), or a combination thereof.

21. A processor for wireless communication, comprising:
at least one controller coupled with at least one memory and configured to cause the processor to:
identify a sensing scenario associated with the processor or an environment that includes the processor; and
transmit, to a network entity, a request message indicates a request for the network entity to perform a radio sensing operation on behalf of the processor and a type of radio sensing operation to be performed by the network entity.
